(19) United States
(12) Patent Application Publication
(10) Pub. No.: US 2013/0260382 A1
(43) Pub. Date: Oct. 3, 2013

(54) SYSTEMS AND METHODS FOR UTILIZING MICROSCOPY

(71) Applicant: INSCOPIX, INC., Palo Alto, CA (US)

(72) Inventors: Kunal Ghosh, Mountain View, CA (US); Eric Cocker, Menlo Park, CA (US); Mark J. Schnitzer, Stanford, CA (US)

(21) Appl. No.: 13/767,814

(22) Filed: Feb. 14, 2013

Related U.S. Application Data
(60) Provisional application No. 61/601,489, filed on Feb. 21, 2012.

(51) Int. Cl. G01N 21/64

(52) U.S. Cl. CPC G01N 21/6486
USPC 435/6.12; 435/287.2

(57) ABSTRACT

Systems and methods are provided for imaging a sample. A portable slide reader may be provided that may be configured to accept a slide and that may contain one or more miniature microscopes therein. The slide reader may include a display showing images captured by the microscopes. The slide may be movable relative to the microscopes and the position of the captured image may be controllable. In some instances, images captured may be useful for DNA sequencing. Multiple color ranges may be captured for a target region, corresponding to different nucleobases.

### CROSS-REFERENCE

This application claims the benefit of U.S. Provisional Patent Application Ser. No. 61/601,489, filed Feb. 21, 2012, which application is entirely incorporated herein by reference.

### BACKGROUND OF THE INVENTION

Conventional light microscopes have had a profound impact on furthering our understanding of life. Fluorescence microscopy, in particular, has emerged as a workhorse tool of modern biology and medicine. However high-performance scientific light microscopes have traditionally been and still remain bulky and expensive instruments. And those microscopes capable of fluorescence imaging are even more complex and expensive, typically housed in a core facility and shared amongst users. If high-performance scientific light microscopy could be brought to each researcher in a biology lab, the resulting increase in throughput would dramatically accelerate research in the life sciences and hence our understanding of life.

The microscope has also provided a technological basis for some forms of nucleic acid sequencing. A need exists for high-performance light microscopy, which may be integrated in a manner that may permit widespread usage, and such an advance could also bring about dramatic acceleration in nucleic acid sequencing capabilities.

### SUMMARY OF THE INVENTION

Systems and methods are provided for a low-cost and portable digital microscope slide reader that literally brings high-performance scientific microscopy into the palm of researchers in the life sciences. The slide reader may have resolution that is fine enough for resolving less than or equal to about 1 micron features in raw images of specimens, and with post-processing can be capable of resolving even finer specimen features. Several fluorescence channels can be supported for imaging specimens labeled with multiple fluorescence markers. Spectral detection capabilities can be included for multi-color detection of fluorescent markers, or of light-scattering markers such as plasmonic nanoparticles.

In one embodiment of the invention the slide reader enables imaging and scanning of a standard microscope slide, akin to using a conventional benchtop fluorescence microscope to image a slide. However, the reader may fit in the palm of a hand and permits visualization of the slide as digital images on, for example, an LCD screen or via USB on a computer.

In another embodiment of the invention, the slide reader can be used for image-based cytometry at the researcher's desk, i.e., the reader can image cells on a slide and in-built algorithms can provide an automated, image-based cell count.

These embodiments can be further modified to permit low-cost, image-based diagnostics, e.g., at the point-of-care and/or at physician office labs. Particular examples of point-of-care diagnostics that could be performed include fluorescence sputum smear microscopy for TB diagnostics and CD4/CD8 counts for HIV/AIDS diagnostics.

The slide reader can also be used for DNA sequencing. A slide may include microfluidics therein, that may be imaged by the microscopes. The markers that distinguish the four different nucleic acid base pairs could be fluorescent markers of 4 different colors or color combinations, plasmonic markers of 4 different spectral signatures, or other optically detectable markers. The images may be analyzed for sequencing.

An aspect of invention is directed to a slide reader comprising: a microscope module comprising one or more microscopes, a microscope having a volume of 5 cubic centimeters or less; and a scan stage configured to accept a slide, wherein the scan stage is movable relative to the microscope. Another aspect of the invention provides a slide reader comprising: a microscope module comprising one or more microscopes, a microscope weighing 4 grams or less; and a scan stage configured to accept a slide, wherein the scan stage is movable relative to the microscope. In some embodiments, the slide reader further comprises a housing, wherein the microscope and the scan stage are within the housing. The slide reader can be a handheld device.

Additional aspects of the invention may include a slide reader comprising: a plurality of microscopes, each microscope capable of detecting different colors; a scan stage configured to accept a slide, wherein the scan stage is movable relative to the microscopes; a housing, wherein the plurality of microscopes and the scan stage are within the housing; and a display showing one or more images captured by the plurality of microscopes, wherein the display is provided on the housing. The slide reader may further comprise a processor in communication with the plurality of microscopes, wherein said processor is capable of analyzing images captured by the plurality of microscopes in different colors.

A method of DNA sequencing is provided in accordance with another aspect of the invention. The method may comprise: providing a plurality of microscopes capable of detecting different colors; providing a slide comprising a target region encompassing one or more microfluidic feature; imaging the target region with the plurality of microscopes capable of detecting different colors; and analyzing the imaged target region based on the different colors detected, thereby determining DNA sequencing. The method may further comprise utilizing a processor in communication with the plurality of microscopes for said analysis of the imaged target region. In some embodiments, the plurality of microscopes are capable of detecting at least four colors. Each color of said at least four colors may render a nucleobase discernible from other types of nucleobases.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a slide reader in accordance with an embodiment of the invention.

FIG. 2 shows an example of a mechanical layer of an embodiment of the slide reader.

FIG. 3 provides an example of a DNA sequencer in accordance with an embodiment of the invention.

FIG. 4 provides an example of a DNA sequencer with a dual fluorescence microscope.

FIG. 5 and FIG. 6 provide examples of a plasmonic sequencer for DNA.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for utilizing microscopy. Examples of such utilizations may include a microscope slide reader and/or DNA sequencing. Various aspects of the invention described herein may be applied to any of the particular applications set forth below or for any other types of imaging or analysis systems. The invention may be applied as a standalone system or method, or as part of an integrated data collection and/or processing system. It shall be understood that different aspects of the invention can be appreciated individually, collectively, or in combination with each other.

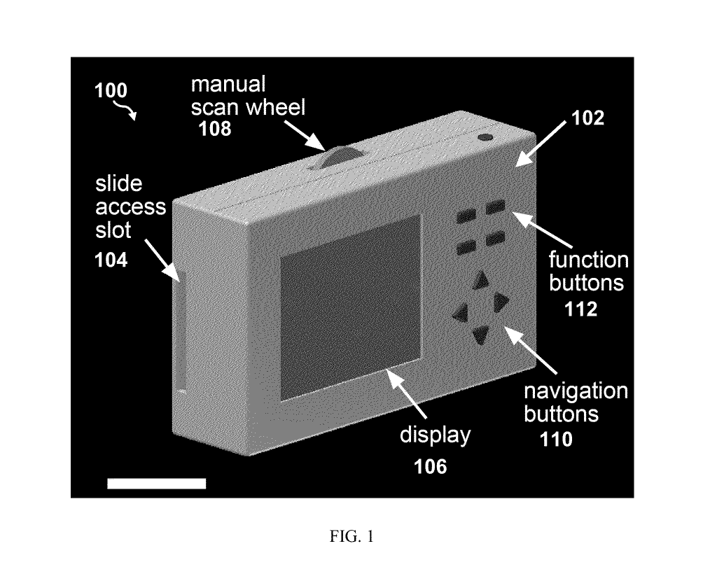

FIG. 1 shows one embodiment of the slide reader in accordance with an embodiment of the invention. The slide reader may comprise a miniature, integrated microscope module, a mechanical layer comprising a slide loader and axial and lateral scroll wheels, an electronics layer comprising microscope control and imaging data acquisition circuits, and/or a display layer consisting of, for example, an LCD screen.

In some instances, a slide reader 100 may have one or more housing 102 that may partially or completely enclose the interior. The housing may partially or completely enclose the integrated microscope module and/or slide when the slide is loaded into the slide reader. The housing may partially or completely enclose the electronics layer.

The slide reader may have one or more slide access slot 104. Any other opening or configuration may be provided by which a slide may be inserted into a slide reader. In some instances, an opening may be provided in a housing 102 of the slide reader. The opening may or may not be closeable. One, two or more slide access slots may be provided in the slide reader.

A display 106 may be provided on the slide reader. In some instances, the display may include a screen. The display may optionally show an image captured by one or more microscope of the slide reader. The display may show a portion of a slide being imaged in real-time. In some instances, multiple portions of a slide may be imaged in real-time. The multiple portions may be shown on the display in real-time. Alternatively, the display may show historical images captured by the slide reader. The display may also show a menu or other features that may permit a user to interact with the slide reader. The display may or may not show data and/or analysis of images captured in the slide reader.

Once a slide is inserted into a slide reader, the slide may be stationary within the slide reader. Alternatively, the slide may be movable within the slide reader. In some instances, a slide reader may include one or more manual scan wheel 108 or other similar mechanism that may permit a portion of the slide reader to move. For example, the slide may move within the slide reader. Alternatively, one or more microscope module may move within the slide reader. A slide and/or microscope may move relative to one another, optionally via one or more manual scan wheel or other mechanism. The mechanism may permit a movable image to be captured by the microscope. In some examples, a single manual scan wheel may be provided. Alternatively, multiple manual scan wheels may be used. Multiple manual scan wheels may permit movement in different directions. For example, a first manual scan wheel may permit movement parallel to a length of the slide reader, while a second manual scan wheel may permit movement parallel to a width of the slide reader. Multiple manual scan wheels may be used to control x-y relative movement between a slide and/or microscope. A user may turn a scroll wheel in a first direction in order for the slide and/or microscope to move relative to one another in a particular direction, and may turn the scroll wheel in a second direction in order for the slide and/or microscope to move relative to one another in the opposite direction. In some instances, one or more mechanism may permit translation and/or rotation of one or more component.

In some instances, the mechanism may permit movement mechanically without requiring electrical power. Alternatively, the mechanism may couple to one or more component that may use electrical power. For example one or more actuator, such as a motor, may be used to move one or more component within the slide reader. In some instances, both mechanical and powered systems may be used in conjunction.

One or more navigation buttons 110 may be included in the slide reader. Other interface devices, such as touchscreens, wheels, levers, slides, or knobs may be used. The navigation buttons may be used to control an image shown on a display 106. For example, the navigation buttons may permit a user to pan an image shown on the display and/or zoom in or out. The navigation buttons may control the microscope and/or slide. For example, the navigation button may cause a microscope to zoom in or out, and/or control the focus. Alternatively, the microscope may be capable of autofocusing when the navigation buttons are utilized. In another example, the navigation buttons may cause the microscope and/or slide to move transversely relative to one another, thus, showing one or more altered image captured by the microscope on the display. In some instances, one or more, two or more, three or more, four or more, five or more, six or more, seven or more, or eight or more navigation buttons may be provided corresponding to different navigational features.

In some instances, one or more function buttons 112 may also be included. Other interface devices, such as touchscreens, wheels, levers, slides, or knobs may be used. In some instances, the function buttons may control a light source used. For example, multiple types of light sources may be provided, and the function buttons may control which light sources are turned on and/or the degree to which they are turned on. The function buttons may correspond to one or more pre-selected functions which may have one or more settings that are predetermined for those functions. In some instances, the functions may be based on the type of material on the slide being analyzed. In some instances, the functions may be based on the type of analysis to be performed.

The slide reader may have a small size. In some embodiments, the slide reader may be a handheld device. The slide reader may fit in a user's palm. The slide reader footprint may be less than or equal to about 20 in², 18 in², 15 in², 13 in², 12 in², 11 in², 10 in², 9 in², 8 in², 7 in², 6 in², 5 in², 4 in², 3 in², 2 in², 1 in², 0.5 in², or 0.1 in². The slide reader may have a volume of less than or equal to about 30, 20, 18, 15, 13, 12, 11, 10, 9, 8, 7, 6, 5, 4, 3, 2, 1, 0.5, 0.3, or 0.1 cubic inches. The slide reader footprint and/or volume may be substantially equal to the housing footprint and/or volume. Alternatively, they may be different. In some instances, the slide reader may have a low weight. For example, the slide reader may weigh less than or equal to about 1 kg, 750 grams, 500 grams, 300 grams, 200 grams, 100 grams, 75 grams, 50 grams, 40 grams, 30 grams, 20 grams, 15 grams, 10 grams, 7 grams, 5 grams, 3 grams, 2 grams, 1 gram, 700 mg, 500 mg, 300 mg, 100 mg, 50 mg, 30 mg, or 10 mg.

As previously described, the slide reader may include a miniature integrated microscope module. In some examples, the miniature microscope module may include one or more microscopes that may be capable of providing images. A single microscope may be provided or a plurality of microscopes may be provided. In some instances, the microscopes may form an array. The microscopes may be arranged in one or more row and/or one or more column. In some instances, one or more groups of microscopes may be provided. One or more miniature microscope module may be provided in the slide reader.

In some instances, one or more microscope may have a fixed position within the slide reader. One or more miniaturized microscope module may have a fixed position within the slide reader. Alternatively, one or more microscope and/or one or more miniature microscope module may be movable within the slide reader. They may be movable relative to the housing. They may or may not be movable relative to one another. A plurality of microscopes may move together so that they are stationary relative to one another. Alternatively, they may be independently movable relative to one another.

The images provided by a microscope may be a static image (e.g., snapshot) or dynamic image (e.g., video). The images may be provided continuous (e.g., continuous video feed) or in a discontinuous (e.g., snapshots or videos taken at discrete times) manner. The microscopes may be broadcasting the images. In some instances, the images may be streaming live. As the images are captured, the microscopes may transmit the images in real-time. Alternatively, the microscopes may store the image and/or send the images after a delay.

The images provided by the microscope may have a high resolution. For example, the microscope may provide one or more images with a resolution of at least or up to about 100 nm, 300 nm, 500 nm, 700 nm, 1 μm, 1.2 μm, 1.5 μm, 2 μm, 2.5 μm, 3 μm, 3.5 μm, 4 μm, 5 μm, 7 μm, 10 μm, 15 μm, 20 μm, 25 μm, 30 μm, 40 μm, 50 μm or 100 μm. The microscope may be capable of cellular and/or subcellular level imaging. In one example, one or more distinct features of a cell may be discernible in the image captured by the microscope. For example, dendrites, or other features may be discernible. The microscope may have any field of view. For example, the field of view may be greater than, less than, or equal to about 0.01 mm², 0.02 mm², 0.05 mm², 0.07 mm², 0.1 mm², 0.15 mm², 0.2 mm², 0.3 mm², 0.4 mm², 0.5 mm², 0.7 mm², 1.0 mm², 1.2 mm², 1.5 mm², 2 mm², 2.5 mm², 3 mm², 3.5 mm², 4 mm², 5 mm², 7 mm², or 10 mm². The size of the field of view may remain the same through the use of the microscope, or may be varied as desired.

The microscope may have one or more characteristics, components, or features as provided in U.S. Patent Publication No. 2012/0062723, which is hereby incorporated by reference in its entirety.

The microscope may include one or more optical elements that will assist with obtaining the images. For example, the microscopes may include one or more lens, mirror, filter, dichroic, beamsplitter, or any other optical element. One or more objective lenses may be provided. The microscope may be capable of magnifying the subject, sample, or specimen being imaged. The optical element may permit light to pass through the optical element. The optical element may reflect all or a portion of the light. The optical element may filter the wavelengths of light or may alter the wavelengths of the light passing through or deflected by the optical element. One or more optical element may be movable with respect to another optical element and/or an illumination source. One or more optical element may be movable with respect to an object being imaged. The optical element may move automatically without intervention by a human. One or more fiberoptic element may or may not be used by the microscope.

An illumination light source may be provided. The illumination light source may be part of the microscope. Alternatively, the illumination source may be separate from the microscope. Light from the illumination light source may be provided to the object being imaged. Response light from the object being imaged may be provided to a light sensing arrangement. Response light from the object may be captured by an image capturing device. Light provided to the sample and/or from the sample may interact with one or more optical element. The light may be passed through, focused, dispersed, and/or reflected by one or more optical element. The light may be used to back-light the object being imaged, front-light the object being imaged, or side-light the object being imaged. Light from the illumination source may approach the object being imaged from any angle(s).

Some examples of illumination light sources may include light emitting diodes (LEDs) or organic light-emitting diodes (OLED). Other light sources such as lasers may be used. In some instances, a dark field, phase, Hoffman modulation contrast, or differential interference contrast illuminator may be used. In some cases, more than one form of illuminator or more than one illumination source may be used. In some instances, the light source may be ambient light and/or optics may be provided to direct/control ambient light. In some instances, the light source may provide light in the visible spectrum. Alternatively, the light source may provide light that includes wavelengths in any spectrum (e.g., visible, infra-red (e.g., near, far infra-red), ultraviolet). One or more illumination light sources may be provided within a housing of the slide reader. Alternatively, one or more illumination light sources may be external to a housing of the slide reader.

The image may be captured by the microscope in a digital and/or analog format. One or more sensor array may be provided. In some instances, a camera may be provided to capture the image. The camera may be a still camera and/or a video camera. An image of the object being imaged may be captured in a single instance (e.g., snapshot, video), or portions of the object may be captured at a time. For example, a scanning technique may be utilized. Data representative of the captured image may be transmitted by the microscope. The data may be digital data. The data may or may not undergo pre-processing at the microscope. For example, the data may be compressed, encrypted, formatted, validated, or undergo any other pre-processing step on board the microscope. The microscope may have a processor that may be capable of performing one or more pre-processing step. In some instances, data compression may be useful for reducing bandwidth used by the microscope, which may be advantageous in high throughput situations.

The image captured by the microscope may be any type of image. For example, the image may include a visible image created by using visible light from the electromagnetic spectrum. The image may be a thermal image using infra-red radiation. In some instances, the image may capture a fluorescent reaction or may be created utilizing fluorescence microscopy. For example, epifluorescent imaging may be utilized, which may include the interaction between an excitation light and the target object, which may cause the generation of imaging fluorescence. The excitation light that reaches the object being imaged may have a wavelength that may be configured for absorption by one or more fluorophores. The fluorophores may emit light at different (e.g., longer or shorter) or the same wavelengths.

In some instances, acoustic imaging, such as ultrasound may be utilized. In some instances, the image may capture an image of scattered or phase-shifted light, such as in dark-field microscopy, differential interference contrast microscopy, Hoffman modulation contrast microscopy, or phase microscopy. For example, a dark-field illuminator might be used in conjunction with a dark field objective and particles that are highly light scattering, such as gold nanorods or other plasmonic nanoparticles, to create a dark-field image. In some instances the interaction may be between the illumination and the target scattering particles, such as plasmonic nanoparticles with specific optical resonances chosen to enhance light scattering at specific optical wavelengths and thus cause the generation of a light scattering image of excellent signal quality due to the chosen optical resonances in the plasmonic particles. The scattered light may undergo spectral analysis or decomposition as part of the detection process, for instance to identify the particular particle species that scattered the light or to distinguish the scattering particle from others in the specimen with different spectral characteristics for light scattering or optical phase-shifts.

In some embodiments, the microscopes may be a miniature microscope. For example, the microscope may weigh less than or equal to about 100 grams, 50 grams, 40 grams, 30 grams, 20 grams, 15 grams, 10 grams, 7 grams, 5 grams, 3 grams, 2 grams, 1 gram, 700 mg, 500 mg, 300 mg, 100 mg, 50 mg, 30 mg, 10 mg, 5 mg, 3 mg, or 1 mg. The microscope may have a small footprint. For example, a microscope may have a footprint of about 10 cm² or less, 5 cm² or less, 4 cm² or less, 3 cm² or less, 2 cm² or less, 1 cm² or less, 0.5 cm² or less, 0.1 cm² or less, 0.05 cm² or less, or 0.01 cm² or less. In some instances, a microscope may have a small volume, such as less than or equal to about 20, 15, 10, 7, 5, 4, 3, 2, 1, 0.5, 0.1, 0.05, or 0.01 cubic centimeters.

One or more portions of the microscope described herein may be enclosed or partially enclosed in a housing 102 of the microscope, and/or a housing for the slide reader.

In some embodiments, the microscope module may be directly incorporated into the slide reader in a permanent manner. The microscope module may be integrally formed into the slide reader. One or more portion of the microscope module may be a unitary piece with one or more portion of the slide reader and/or be permanently affixed. Alternatively, the microscope module may be housed in a detachable attachment that could be plugged into the slide reader for imaging with a loaded slide. The microscope module, whether permanently incorporated into the slide reader or housed in a detachable attachment, can be multiplexed into an array of modules for imaging multiple fields-of-view in parallel. In some instances, arrays of microscopes may be provided in a microscope module and may simultaneously image different fields of view in parallel. The fields of view may correspond to the positions of the microscopes. Overlap may or may not be provided in the fields of view.

In the embodiment of the invention shown in FIG. 1, a mechanical layer may be provided in the slide reader. The mechanical layer may include one or more scroll wheels 108. The scroll wheels may be used to move a slide axially and laterally. Lateral scrolling may be permitted in one or more directions. The slide may contain a sample to be imaged. The sample may be a biological sample, such as a bodily fluid, tissue, or other biological matter. Alternatively, the sample may include environmental, agricultural, chemical, product, or other samples. In another embodiment, the scroll wheels may move the microscope module, or array of modules, axially and laterally. Scroll wheels may cause a slide to move relative to one or more microscope module. As previously described, any description herein of scroll wheels may apply to any other mechanism that may permit the mechanical movement as described. For example, any sort of actuator may be provided, whether it be mechanical, electrical, magnetic, pneumatic, hydraulic, or any combination thereof, that may permit the control of the relative positions of the microscope module and the slide.

Once the slide is loaded and imaging commences, images of the slide may be streamed in real-time to the display. The images may include static images (e.g., snapshots) or continuous images (e.g., video). In some embodiments, once inserted the slide will be locked into place so that the center of the slide lies in the focal plane of the microscope module or modules. In such embodiments, focusing can still be adjusted via an axial scroll wheel. Lateral scroll wheels may permit manual scanning across the slide. Lateral scroll wheels may permit scanning prior to the slide being locked into place. In some embodiments lateral scrolling may or may not be permitted after the slide is locked into place.

If a contiguous image of a large region of the slide is desired, a semi-automated scanning mechanism in conjunction with a combination of an array of the microscope modules and image mosaic or stitching software can image an approximately 1 in² area on the slide at sub-micron resolution in tens of seconds. In some instances, a semi-automated scanning mechanism may be used to image a desired area. The microscope modules may move relative to the slide to scan an area. The area may be any size including but not limited to about 0.001 in², 0.005 in², 0.01 in², 0.05 in², 0.1 in², 0.3 in², 0.5 in², 0.7 in², 1 in², 1.3 in², 1.5 in², 1.7 in², 2 in², 2.5 in², 3 in², 3.5 in², 4 in², or 5 in².

In some instances, scroll wheels may be used to perform relatively large lateral movements. For example, scroll wheels may be used to capture an image of a portion of a slide. In some instances, additional mechanisms may be used to provide more fine-controlled lateral movements. For example, navigation buttons may be used to perform more controlled panning activities. In some instances, one or more actuator may assist with performing more fine movements. In some instances, as previously mentioned, one or more automated scanning feature may be performed once the slide is substantially at a desired position relative to one or more microscope.

Images displayed can be directly captured and stored in memory for future retrieval and transmittal to a computer via, for example, a USB interface, or for wireless transmittal to a remote location. Image data may be transmitted via a wired connection or wirelessly. Image data may be transmitted over a network, such as a local area network (LAN) or wide area network (WAN) such as the Internet. In some embodiments images may be streamed and displayed in real-time on an external computer via, for example, USB.

In some embodiments, the images may be displayed on the slide reader device. In some instances, the slide reader device may have a display layer. The display layer may include any form of display 106 as known or later developed in the art. For example, an LCD screen, plasma screen, touchscreen, LED display, or OLED display may be provided. The images may be displayed in real-time. A user may view the display and adjust the slide positioning laterally and/or axially accordingly. The user may view the display to determine whether the image is focused and adjust accordingly. The user may view the display to scan to an area of the image of interest.

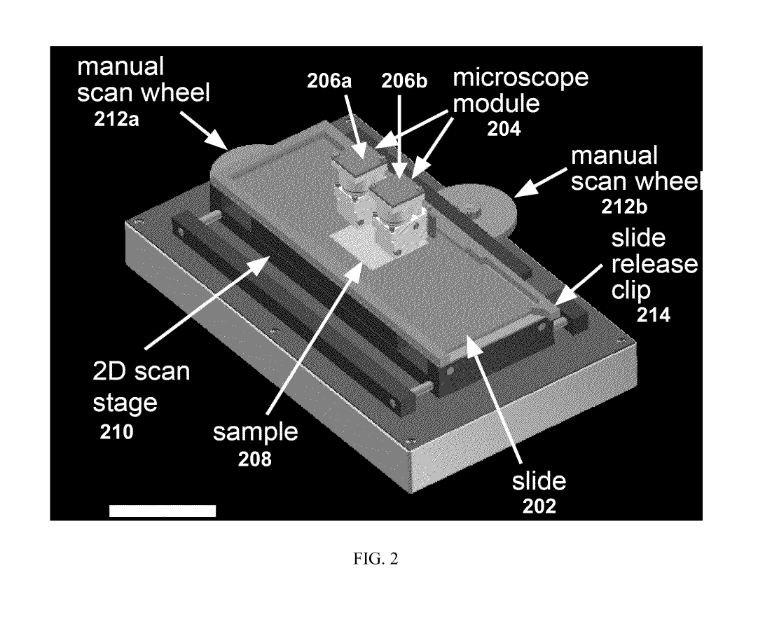

FIG. 2 shows a mechanical layer of an embodiment of the slide reader. In some instances, the slide reader may be the same or similar to a slide reader shown in FIG. 1.

FIG. 2 shows a slide 202 loaded and ready to be scanned by one or more miniature microscope module 204. In some embodiments a microscope module may support dual-color fluorescence imaging with two component microscopes 206a, 206b (one for each color channel, e.g., channel1: blue excitation/green emission; channel2: green excitation/red emission). In dual-color mode progressively scanning the module across the slide in a defined pattern and thus imaging each field-of-view region on the slide twice—once with each color channel—permits constructing a dual-color image of the field-of-view. The same principles for dual-color imaging may apply to any form of multi-color fluorescence imaging. Any number of colors may be supported, with a corresponding number of component microscopes. In multi-color mode, the scan may occur any requisite number of times. For example, multi-color fluorescence imaging may include four-color imaging, and the scan may occur four times. In another example, multi-color fluorescence imaging may include eight-color imaging and the scan may occur eight times. In some instances, during a multi-color scan, the module may move across a region once, while the multiple microscopes belonging to the module may cause the region to imaged multiple times. Alternatively, in some instances, the module itself may move across the region multiple times. In some instances one, two or more microscopes may be per provided for color/spectrum of scan.

A slide 202 may have a region that supports a sample 208. The sample may be provided on a target region to be imaged.

The slide may be provided on a scan stage 210. The scan stage may be a two-dimensional scan stage. The scan stage may move relative to the rest of the slide reader and/or the microscope module. Alternatively, the microscope module may move relative to the rest of the slide reader and/or the scan stage. Any combination of movement by the scan stage and microscope module may occur. The slide may be held onto the scan stage and move with the scan stage. In some instances, the scan stage may be provided on one or more set of rails, along which the scan stage may slide.

One or more manual scan wheels 212a, 212b may be provided. The manual scan wheels may control lateral movement of the scan stage 210 and/or microscope module 204. In one example, turning a scan wheel may cause a corresponding lateral movement by a scan stage and/or microscope module. For instance, turning a first manual scan wheel 212a may cause the scan stage to move in a direction parallel to the width of the slide reader, while turning a second manual scan wheel 212b may cause the scan stage to move in a direction parallel to the length of the slide reader. A manual scan wheel may have teeth that may engage with one or more teeth of a scan stage.

As previously described, any form of actuation mechanism or combinations of actuation mechanisms may be used to cause movement of the scan stage and/or microscope module.

In some embodiments, a slide may fit into one or more groove or holder of the scan stage. A slide may be affixed to the scan stage while a sample 208 is being imaged. A slide release clip 214 may be provided, which may permit a slide to be removed from the scan stage.

The microscopes may be arranged in any fashion in one or more microscope module, and any scanning patterns may be used. For example, one or more rows and/or columns of microscopes may be provided. One or more microscope module may move lengthwise along a target region to image a sample. In some instances, one or more microscope module may also move widthwise. A snaking path, or any other path may be taken to image the desired target region. The imaging path may be determined manually by a user, or may be occur automatically without requiring user intervention while in progress.

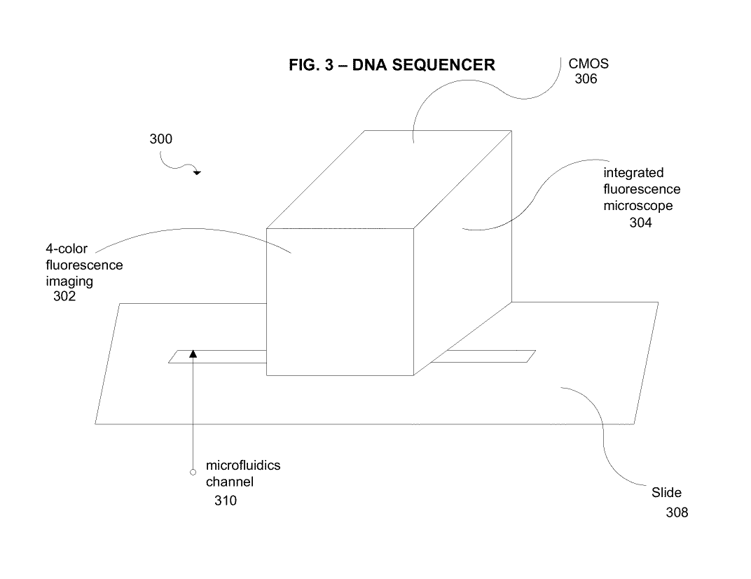

FIG. 3 provides an example of a DNA sequencer 300 in accordance with an embodiment of the invention. The DNA sequencer may be part of a slide reader. The slide reader may have any characteristics, components, or features as described elsewhere herein. The slide reader may be used for DNA sequencing. Alternatively, the sequencer may be its own device or part of another device. The DNA sequencer may utilize an integrated microscope. The microscope may have one or more features of a microscope described elsewhere herein. The microscope may be a fluorescence microscope. A micro-fluidics chamber or chip may be used to deliver reagents to the specimen plane of the microscope, to facilitate optical detection of the DNA sequence. In some embodiments these reagents may facilitate fluorescence based DNA sequencing.

In other embodiments these reagents may facilitate sequencing using dark field, differential interference contrast, Hoffman modulation contrast, or phase microscopy and scattering of light or light that has undergone phase-shifts. These reagents may be plasmonic nanoparticles, with specific sizes chosen so as to have optical resonances at specific wavelengths of light, so as to enhance light scattering in a manner that will allow the four DNA base pairs to be distinguished via four distinct spectral patterns of light scattering. Sequencing may also be performed with such reagents, via optical fluorescence or scattering or phase-shifts, without the use of microfluidics delivery.

In some embodiments, multi-color imaging may be utilized by the sequencer. For example, the sequencer may utilize four-color fluorescence imaging. A single microscope module may be utilized for the four-color imaging 302. One or more integrated fluorescence microscope 304 may be used. The microscope module may be movable relative to a sample to be imaged. In some instances, the microscope module may scan the sample to be imaged multiple times. For example, for four-color imaging, the microscope module may scan the sample to be imaged four times.

The microscope or microscope module may include any type of image sensor. For example, a complementary metal oxide semiconductor (CMOS) sensor 306 may be used. Alternatively CCD or other image sensing technologies may be utilized.

A slide 308 may be provided in the DNA sequencer. The slide may have one or more microfluidics channel 310. The channel may include a sample to be sequenced. The contents of the channel may be imaged by the microscope. In some instances, static images relating to the one or more slide channels may be captured. Alternatively, video feeds of the slide channel may be captured. Video feeds may permit viewing of dynamic changes over time. Images may be captured of a sample flowing through the channel. In some instances, images may be captured of the sample remaining stationary, or after a sample has flowed through the channel.

The microscope(s) may be stationary relative to the features of the slide being imaged while the imaging is occurring. Alternatively, the microscope(s) may move relative to the slide during imaging. In some instances a plurality of microscopes may be used for the same field of view, or for different field of views. The fields of view for the microscopes may or may not overlap. In some instances, microscopes of different times (e.g., different colors or spectrums) may simultaneously image the same field of view. In some instances, microscopes (e.g., of the same type of different types) may simultaneously image different fields of views. In some instances, the different fields of view may be combined or stitched together to form a larger overall image.

Any description herein of a microfluidics channel may apply to any other type of microfluidics feature, and vice versa, which may include channels, grooves, reservoirs, chambers, wells, substrates, or any other feature. The microfluidics may be etched or formed into the slide. In some instances, one or more actuation mechanism may assist with controlling fluid flow. Examples of actuation mechanisms may include pumps (e.g., utilizing mechanics, electrostatics, etc.), valves, or other actuation mechanisms. In some embodiments, capillary forces, pressure differentiation, and/or gravity may assist with fluid flow.

In some embodiments, a template, a labeled primer, DNA polymerase, and/or dNTP may be provided in the microfluidics channel. In some instances, gel electrophoresis may be performed using the sequencer device. Any DNA sequencing technique known in the art may be utilized. The microscope may capture images of the sequencing process and/or aftermath.

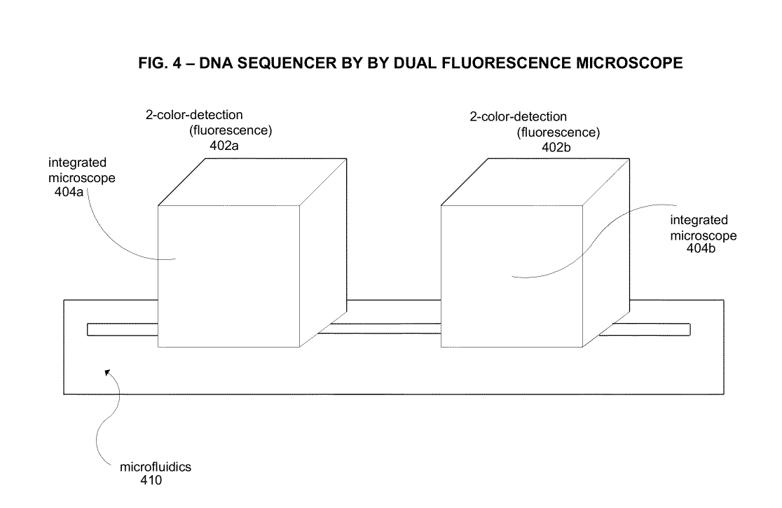

FIG. 4 provides an example of a DNA sequencer with a dual fluorescence microscope 402a, 402b. For example, a plurality of microscopes/microscope modules 404a, 404b may be provided. Each microscope module may include one or a plurality of microscopes. The plurality of microscopes/microscope modules may be multi-color detectors. In one example, two microscopes may be provided, each capable of performing two-color detection. The two-color detection performed by each of the two microscopes may be different. In another example, two microscopes may be provided, and one may perform three-color detection while the other performs one-color detection. In some instances, four microscopes may be provided, each performing one-color detection. In some instances, a desired number of colored detection N may be provided, and any number of microscopes and/or microscope modules may be provided, performing some color detection, wherein the total number of color detection over the one or more microscopes and/or microscope modules adds up to N. In some instances, the total number of microscopes and adds up to N. For example, N may equal 4. N may equal 1, 2, 3, 4, 5, 6, 7, 8, or may have any other value that may be useful for sequencing.

The multi-microscope sequencer may be used to image a sample on a slide. The slide may contain one or microfluidic features 410, as those described elsewhere herein.

Any number of microfluidic features may be provided for a multi-microscope sequencer. In some instances, one or more channel may be provided. In some instances, a plurality of channels may be provided. The plurality of channels or other microfluidic features may be fluidically isolated from one another. Alternatively, they may be in fluid communication with one another. A plurality of microscopes (e.g., two microscopes) may be imaging the same channel or other microfluidic feature. Alternatively, the plurality of microscopes/modules may image different channel(s) and/or other microfluidic features.

In some embodiments, a plurality of microscopes/modules may be movable. They may be movable relative to a microfluidic feature. They may or may not be movable relative to one another. In some instances, they may be used to scan the same microfluidic feature, and/or the same area of the same microfluidic feature. In some instances, each target region of the microfluidic feature may at least be imaged and/or scanned for N colors and/or by N microscopes.

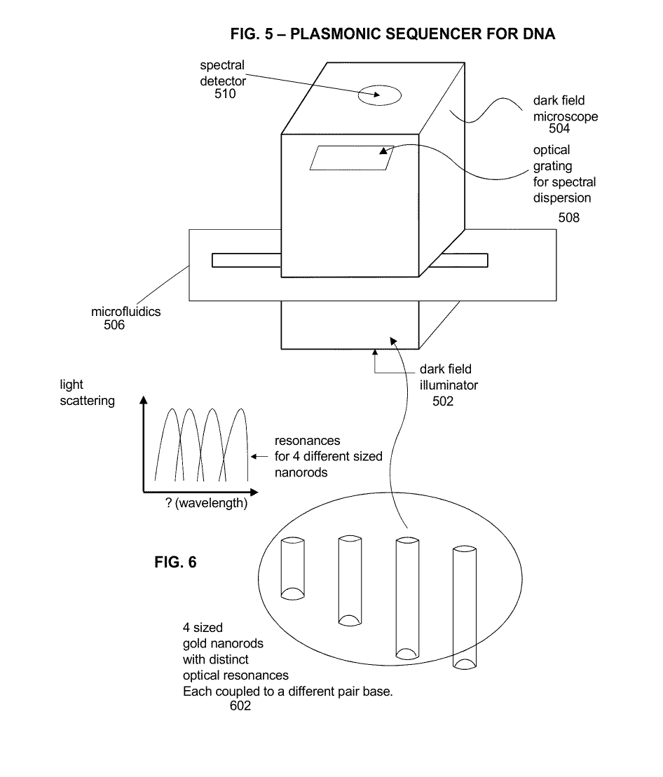

FIG. 5 and FIG. 6 provide examples of a plasmonic sequencer for DNA. The plasmonic sequencer may utilize alternative imaging techniques. For example, a dark field illuminator 502 and dark field microscope 504 may be provided. The dark field illuminator may include a plurality of nanorods 602. In some instances, four sized nanorods may be provided with distinct optical resonances. In some instances, each nanorod may be coupled to a different base pair. In some instances, the interactions of the plasmonic nanoparticles may be detected by phase microscopy, Hoffman modulation contrast microscopy, or differential interference microscopy.

The plasmonic sequencer may image a sample which may be provided on a slide. The slide may include microfluidics 506, such as microfluidic channels. In some instances, the dark field illuminator may be provided on an opposing side of the slide from the dark field microscope. Alternatively, the dark field illuminator may be provided on the same side of the slide. In some instances, the optics may include an optical grating for spectral dispersion 508. In some instances an optical prism may be used for spectral dispersion. In some instances an optical filter or filters may be used for spectral dispersion or separation. A spectral detector 510 may be provided that may be useful for detecting optical signals that have passed through the optical grating, prism, or filter(s).

The resonances from the different sized nanorods may be provided at different wavelengths. Light scattering may vary over the different wavelengths for the different sized nanorods. This may provide optical differentiation that may be captured by the spectral detector.

The slide may be capable of moving relative to the dark field microscope and/or illuminator, and/or vice versa. In some instances, a dark field microscope module may be provided. The dark field microscope module may include a single microscope or a plurality of microscopes. In some alternate embodiments, a plurality of microscope modules may be provided.

The slide may be capable of moving relative to the phase, Hoffman modulation contrast, or differential interference contrast microscope and/or the corresponding phase, Hoffman, or differential interference contrast illuminator, and/or vice versa. In some instances, a phase, Hoffman modulation contrast, or differential interference microscope module may be provided. This microscope module may include a single microscope or a plurality of microscopes. In some alternate embodiments, a plurality of microscope modules may be provided.

In some embodiments, one or more control, such as a scroll wheel may be provided that may permit the slide to move laterally and/or axially with respect to the microscope and/or illuminator. Any other illuminator may be utilized. The plasmonic sequencer may be incorporated as part of a slide reader or may be separate from the slide reader.

The images may be used for DNA sequencing. The images captured using the microscopes may be imaged in multi-color mode (e.g., four color mode) which may be used to identify and/or sequence nucleic acids. For example, in four color mode, each color may correspond to a distinct nucleobase (e.g., adenine, guanine, cytosine, and thymine), or other feature useful for sequencing DNA. The images may be analyzed with the aid of a processor. In some instances, the images may be analyzed automatically without requiring human intervention. A memory and processor may be provided, wherein the memory may store tangible computer readable media comprising code, logic, and instructions for performing one or more step. The processor may carry out one or more step provided by non-transitory computer readable media. Alternatively, the images may be displayed to a human who may perform analysis.

The images may be displayed on the same device that captures the images. Alternatively, they may be displayed on a separate device.

The systems and methods provided herein may be used for a variety of applications. For example, the slide reader system and/or microscope module systems herein may be used to image any microfluidic structures. The systems and methods provided may be used for multi-color or multi-spectrum imaging. In some instances the systems and methods may be used for DNA sequencing.

The systems and methods provided herein may advantageously permit the function of any form of high throughput processing. A plurality of microscopes may operate in parallel to image multiple fields of view simultaneously. One or more microscopes may be highly portable and may enable use out in the field. This may have, but are not limited to, industrial applications, applications in clinical and pre-clinical studies, applications in the development of pharmaceuticals/therapeutics, and/or diagnostic applications.

Systems and methods provided herein may also be used for plant biology applications. One or more microscope may be used to image a plant sample in the field. The microscope may be a standalone microscope, plurality of microscopes, or provided within a slide reader having one or more microscopes therein. The microscopes may be miniature and portable, and may have any of the characteristics described. The microscopes may operate under any modality or combination of modalities, which may include fluorescence, bright field, or dark field modalities. In some instances, the microscopes may be capable of operating under multiple modalities and a user may select one or more modality for use. Digital images of a sample may be stored locally on the one or more microscopes or slide reader, or may be transmitted. In some instances, the digital images may be transmitted via a USB link or wirelessly, e.g., via Bluetooth.

Space applications may be achieved using the systems and methods described herein. For instance, one or more microscopes may be used for imaging under zero-gravity conditions. The systems and methods may include a standalone microscope, plurality of microscopes, or may be provided within a slide reader having one or more microscopes therein. The microscopes may be miniature and portable, and may have any of the characteristics described. The housings of the microscopes may be specially designed for imaging under zero-gravity conditions. The housing may permit portions to be self-contained and fixed in zero-gravity. A small mass miniature microscope may advantageously be enabled for high-performance microscopy in space.

Systems and methods provided herein may provide mobile microscopy for consumer applications. In some instances, microscope attachments may be provided for enabling high performance microscopy on-the-go. For example the microscope attachments may be compatible with mobile devices, such as laptops, cell phones, smartphones, tablets, digital camera, or any other mobile device. In one example, the microscope modules/attachments may snap on a back-facing camera of a cellphone or smartphone, or be integrated with the optical and image sensing elements of the phone. Thus, a mobile device such as a cell phone may be converted to a high-performance microscopy platform. Different modules/attachments could enable different modalities of microscopy (e.g., bright field, dark field, phase contrast, fluorescence). For example, a user may be able to select an attachment from a plurality of potential attachments based on the desired modality. Alternatively, one or more attachment may provide one, two or more modalities.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A slide reader comprising:
a microscope module comprising one or more microscopes, a microscope having a volume of 5 cubic centimeters or less;
a scan stage configured to accept a slide, wherein the scan stage is movable relative to the microscope.

2. The slide reader of claim 1 further comprising a housing, wherein the microscope and the scan stage are within the housing.

3. The slide reader of claim 1 wherein the slide reader is a handheld device.

4. The slide reader of claim 1 wherein the slide reader has a footprint of 12 square inches or less.

5. The slide reader of claim 1 wherein the slide reader has a weight of 300 grams or less.

6. The slide reader of claim 1 further comprising a display showing one or more images captured by the one or more microscopes.

7. The slide reader of claim 6 wherein the images on the display are shown in real-time.

8. The slide reader of claim 6 wherein the display is provided on a housing, wherein the microscope and scan stage are within the housing.

9. The slide reader of claim 2 wherein the housing comprises a slide access slot configured to accept a slide onto the scan stage.

10. The slide reader of claim 1 comprising a manual scan wheel configured to move the scan stage in a first direction relative to the microscope when turned by a user.

11. The slide reader of claim 10 further comprising a second manual scan wheel configured to move the scan stage in a second direction relative to the microscope when turned by the user.

12. The slide reader of claim 11 wherein the second direction is orthogonal to the first direction.

13. The slide reader of claim 6 further comprising one or more navigation buttons configured to adjust the images shown on the display.

14. The slide reader of claim 6 further comprising one or more function buttons configured to adjust the use of the one or more microscopes.

15. The slide reader of claim 14 wherein the use of different function buttons result in different types of images being shown on the display.

16. The slide reader of claim 1 wherein the microscope is capable of providing one or more image with a resolution of at least 3 μm.

17. The slide reader of claim 1 wherein the microscope is capable of capturing a field of view of greater than 0.5 square mm.

18. The slide reader of claim 2 further comprising a light source within the housing, wherein light from the light source configured to be directed to a target region to be imaged.

19. The slide reader of claim 1 further comprising a slide loaded onto the scan stage, wherein the slide comprises a sample to be imaged by the one or more microscopes.

20. The slide reader of claim 19 wherein the sample comprises a biological sample.

21. The slide reader of claim 19 wherein the slide hosts a fluorescent reaction and fluorescence microscopy is utilized to capture an image.

22. The slide reader of claim 19 wherein the microscopes capture an image of scattered or phase-shifted light.

23. A slide reader comprising:
a microscope module comprising one or more microscopes, a microscope weighing 4 grams or less;
a scan stage configured to accept a slide, wherein the scan stage is movable relative to the microscope.

24. The slide reader of claim 23 further comprising a housing, wherein the microscope and the scan stage are within the housing.

25. The slide reader of claim 23 wherein the slide reader is a handheld device.

26. The slide reader of claim 23 wherein the slide reader has a footprint of 12 square inches or less.

27. The slide reader of claim 23 wherein the slide reader has a weight of 300 grams or less.

28. The slide reader of claim 23 further comprising a display showing one or more images captured by the one or more microscopes.

29. The slide reader of claim 28 wherein the images on the display are shown in real-time.

30. The slide reader of claim 28 wherein the display is provided on a housing, wherein the microscope and scan stage are within the housing.

31. The slide reader of claim 24 wherein the housing comprises a slide access slot configured to accept a slide onto the scan stage.

32. The slide reader of claim 23 comprising a manual scan wheel configured to move the scan stage in a first direction relative to the microscope when turned by a user.

33. The slide reader of claim 32 further comprising a second manual scan wheel configured to move the scan stage in a second direction relative to the microscope when turned by the user.

34. The slide reader of claim 33 wherein the second direction is orthogonal to the first direction.

35. The slide reader of claim 28 further comprising one or more navigation buttons configured to adjust the images shown on the display.

36. The slide reader of claim 28 further comprising one or more function buttons configured to adjust the use of the one or more microscopes.

37. The slide reader of claim 36 wherein the use of different function buttons result in different types of images being shown on the display.

38. The slide reader of claim 23 wherein the microscope is capable of providing one or more image with a resolution of at least 3 μm.

39. The slide reader of claim 23 wherein the microscope is capable of capturing a field of view of greater than 0.5 square mm.

40. The slide reader of claim 24 further comprising a light source within the housing, wherein light from the light source configured to be directed to a target region to be imaged.

41. The slide reader of claim 23 further comprising a slide loaded onto the scan stage, wherein the slide comprises a sample to be imaged by the one or more microscopes.

42. The slide reader of claim 41 wherein the sample comprises a biological sample.

43. The slide reader of claim 41 wherein the slide hosts a fluorescent reaction and fluorescence microscopy is utilized to capture an image.

44. The slide reader of claim 41 wherein the microscopes capture an image of scattered or phase-shifted light.

45. An slide reader comprising:
a plurality of microscopes, each microscope capable of detecting different colors;
a scan stage configured to accept a slide, wherein the scan stage is movable relative to the microscopes;
a housing, wherein the plurality of microscopes and the scan stage are within the housing; and
a display showing one or more images captured by the plurality of microscopes, wherein the display is provided on the housing.

46. The slide reader of claim 45 further comprising a processor in communication with the plurality of microscopes, wherein said processor is capable of analyzing images captured by the plurality of microscopes in different colors.

47. The slide reader of claim 45 wherein the slide reader is a handheld device.

48. The slide reader of claim 45 wherein the slide reader has a footprint of 12 square inches or less.

49. The slide reader of claim 45 wherein the slide reader has a weight of 300 grams or less.

50. The slide reader of claim 45 wherein a microscope of said plurality has a volume of 5 cubic centimeters or less.

51. The slide reader of claim 45 wherein a microscope of said plurality has a weight of 4 grams or less.

52. The slide reader of claim 45 wherein the images on the display are shown in real-time.

53. The slide reader of claim 45 wherein the housing comprises a slide access slot configured to accept a slide onto the scan stage.

54. The slide reader of claim 45 comprising a manual scan wheel configured to move the scan stage in a first direction relative to the microscope when turned by a user.

55. The slide reader of claim 54 further comprising a second manual scan wheel configured to move the scan stage in a second direction relative to the microscope when turned by the user.

56. The slide reader of claim 55 wherein the second direction is orthogonal to the first direction.

57. The slide reader of claim 45 further comprising one or more navigation buttons configured to adjust the images shown on the display.

58. The slide reader of claim 45 further comprising one or more function buttons configured to adjust the use of the one or more microscopes.

59. The slide reader of claim 58 wherein the use of different function buttons result in different types of images being shown on the display.

60. The slide reader of claim 45 wherein the microscope is capable of providing one or more image with a resolution of at least 3 μm.

61. The slide reader of claim 45 wherein the microscope is capable of capturing a field of view of greater than 0.5 square mm.

62. The slide reader of claim 45 further comprising a light source within the housing, wherein light from the light source configured to be directed to a target region to be imaged.

63. The slide reader of claim 45 further comprising a slide loaded onto the scan stage, wherein the slide comprises a sample to be imaged by the one or more microscopes.

64. The slide reader of claim 63 wherein the sample comprises a biological sample.

65. The slide reader of claim 63 wherein the slide hosts a fluorescent reaction and fluorescence microscopy is utilized to capture an image.

66. The slide reader of claim 63 wherein the microscopes capture an image of scattered or phase-shifted light.

67. The slide reader of claim 45 wherein said plurality of microscopes are capable of detecting at least four colors.

68. The slide reader of claim 67 wherein each color of said at least four colors renders a nucleobase discernible from other types of nucleobases.

69. The slide reader of claim 45 wherein said plurality of microscopes are provided within one microscope module.

70. The slide reader of claim 45 wherein said plurality of microscopes are distributed between a plurality of microscope modules.

71. A method of DNA sequencing comprising:
providing a plurality of microscopes capable of detecting different colors;
providing a slide comprising a target region encompassing one or more microfluidic feature;
imaging the target region with the plurality of microscopes capable of detecting different colors; and
analyzing the imaged target region based on the different colors detected, thereby determining DNA sequencing.

72. The method of claim 71 further comprising utilizing a processor in communication with the plurality of microscopes for said analysis of the imaged target region.

73. The method of claim 71 wherein said plurality of microscopes are capable of detecting at least four colors.

74. The method of claim 73 wherein each color of said at least four colors renders a nucleobase discernible from other types of nucleobases.

75. The method of claim 71 further comprising providing said plurality of microscopes within one microscope module.

76. The method of claim 71 further comprising distributing said plurality of microscopes between a plurality of microscope modules.

77. The method of claim 71 further comprising enclosing said plurality of microscopes and said slide within a housing.

78. The method of claim 77 further comprising accepting said slide in a scan stage movable relative to said plurality of microscopes.

79. The method of claim 78 wherein said housing is part of a handheld device.

80. The method of claim 78 wherein the housing has a footprint of 12 square inches or less.

81. The method of claim 78 wherein the housing has a weight of 300 grams or less.

82. The method of claim 71 wherein a microscope of said plurality has a volume of 4 cubic centimeters or less.

83. The method of claim 71 wherein a microscope of said plurality has a weight of 3 grams or less.

84. The method of claim 77 further comprising showing the images on a display on the housing in real-time.

85. The method of claim 78 further comprising rotating a manual scan wheel, thereby moving the scan stage in a first direction relative to the microscope.

86. The method of claim 85 further comprising rotating a second manual scan wheel, thereby moving the scan stage in a second direction relative to the microscope.

87. The method of claim 86 wherein the second direction is orthogonal to the first direction.

88. The method of claim 84 further comprising adjusting the images on the display via one or more navigation buttons.

89. The method of claim 71 wherein a microscope of said plurality is capable of providing one or more image with a resolution of at least 3 μm.

90. The method of claim 71 wherein a microscope of said plurality is capable of capturing a field of view of greater than 0.5 square mm.

91. The method of claim 77 further comprising controlling a light source within the housing and directing light from said light source to a target region to be imaged.

92. The method of claim 91 wherein the light source is a dark field illuminator and a microscope of said plurality is a dark field microscope.

93. The method of claim 92 wherein the dark field illuminator includes a plurality of nanorods with distinct optical resonances.
